(19) United States
(12) Patent Application Publication
(10) Pub. No.: US 2007/0287334 A1
(43) Pub. Date: Dec. 13, 2007

(54) Flat tube adapted for heat exchanger

(75) Inventors: Kenji Yagisawa, Tokyo (JP); Shiro Ikuta, Tokyo (JP); Kazunori Namai, Tokyo (JP); Takashi Machida, Tokyo (JP); Ryuji Fuse, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/802,316

(22) Filed: May 22, 2007

(30) Foreign Application Priority Data
Jun. 13, 2006 (JP) 2006-163077

(51) Int. Cl. H01R 24/00

(52) U.S. Cl. 439/637

(57) ABSTRACT

A flat tube includes pairs of dimple portions in a longitudinal direction thereof. Each of the pairs has a first dimple portion and a second dimple portion, which are slanted with respect to an intermediate line extending in the longitudinal direction at an intermediate position in a lateral direction so that inner end wall portions of the first and second dimple portions are located on the intermediate line, and so that the outer end wall potions thereof depart from the intermediate line in the lateral direction to be toward outer sides of the tube, respectively. The pairs of dimple portions are set to satisfy a relationship expressed by an inequality: 3≦L2/L1≦12, where L1 is a longitudinal projection length obtained by projecting one of the first and second dimple portions on the intermediate line, and L2 is a longitudinal pitch between adjacent pairs.

### BACKGROUND OF THE INVENTION

1. Field of the Invention

The present invention relates to a flat tube adapted for a heat exchanger equipped with a core part having a plurality of flat tubes and fins which are arranged between the adjacent flat tubes thereof.

2. Description of the Related Art

A conventional flat tube of this kind is disclosed in Japanese patent laid-open publication No. (Tokkaihei) 11-337284. This conventional flat tube is shaped has an upper flat-surface wall portion, a lower wall flat-surface and two curved-surface wall portions continuously connecting side-end portions of the flat-surface wall portions, respectively, being formed in a rectangle in cross-section to flow cooling medium therein. The upper flat-surface wall portion and the lower flat-surface wall portion are formed to have pairs of dimple portions arranged in a longitudinal direction of the flat tube, where a pair of the dimple portions thereof consists a first dimple portion and a second dimple portion. The first dimple portion and the second dimple portion are slanted with respect to a center line extending in the longitudinal direction and in parallel with side-end portions thereof so that their inner end portions are positioned on the center line, and so that their outer end portions of the first and second dimple portions are positioned at downstream side thereof and away from the center line to be on the opposite side of the center line. In addition, the inner end portions of the first and second dimple portions are dislocated from each other in the longitudinal direction.

The cooling medium flowing in the tube hits the first and second dimple portions to independently swirl, and then their swirls in reverse directions encounter each other to generate stronger swirl, thereby efficiently destroying a boundary layer formed on inner surfaces of the wall portions to improve its heat transfer efficiency.

The above known conventional flat tube, however, encounters a problem in that there is room for improving heat radiation efficiency keeping flow resistance of the cooling medium because of lack of allowing for optimum pitch between the dimple portions of the adjacent pairs of the dimple portions, although an off-set amount between the first and second dimple portions and their slanted angles are set optimally.

It is, therefore, an object of the present invention to provide a flat tube which overcomes the foregoing drawbacks and can improve heat radiation efficiency, suppressing flow resistance of cooling medium.

### SUMMARY OF THE INVENTION

According to an aspect of the present invention there is provided a flat tube, which is adapted for a heat exchanger, the flat tube including an upper flat wall portion having two side-end portions, a lower flat wall portion having two side-end portions, and two side wall portions continuously connecting the side-end portions of the upper flat wall portion and the side-end portions of the lower flat wall portions, respectively, to from a rectangular cross-sectional passage of cooling medium inside the flat tube. At least one of the upper flat wall portion and the lower flat wall portion is provided with a plurality of pairs of dimple portions which project toward the passage and arranged in a longitudinal direction of the flat tube, each of the pairs of the dimple portions including a first dimple portion and a second dimple portion which have the same length and are dislocated from each other in the longitudinal direction, the first dimple portion having an inner end wall portion and an outer end wall portion, and the second dimple portion having an inner end wall portion and an outer end wall portion. The first dimple portion and the second dimple portion are slanted with respect to an intermediate line extending in the longitudinal direction at an intermediate position in a lateral direction of the flat tube so that the inner end wall portion of the first dimple portion and the inner end wall portion of the second dimple portion are located on the intermediate line, and so that the outer end wall potion of the first dimple portion and the outer end wall portion of the second dimple portion depart from the intermediate line in the lateral direction to be toward the side-end portions, respectively. The pairs of dimple portions are set to satisfy a relationship expressed by an inequality: 3≦L2/L1≦12, where L1 is a longitudinal projection length obtained by projecting one of the first and second dimple portions on the intermediate line, and L2 is a longitudinal pitch between adjacent pairs of the dimple portions.

Therefore, the flat tube of the invention can promote turbulence of the cooling medium and suppress flow resistance to improve heat radiation efficiency.

### BRIEF DESCRIPTION OF THE DRAWINGS

The objects, features and advantages of the present invention will become apparent as the description proceeds when taken in conjunction with the accompanying drawings, in which:

FIG. 1 is a perspective view showing a part of a flat tube, of an embodiment according to the present invention, which has pairs of dimple portions and is used for a heat exchanger;

FIG. 2 is a plan view illustrating configurations and sizes of dimple portions of the flat tube of the embodiment;

FIG. 3 is a cross sectional view of the flat tube, taken along a line S3-S3 in FIG. 2;

FIG. 4 is a plan view of the dimple portions for illustrating a relationship between a pitch of the adjacent dimple portions and a projected length of the dimple portion with respect to an intermediate line;

FIG. 5 is a diagram illustrating a relationship of the embodiment and a normal flat tube between a ratio of the pitch to the projected length and a heat radiation amount ratio when a flow rate is varied;

FIG. 6 is a diagram illustrating a relationship of the embodiment and the normal flat tube between the ratio of the pitch to the projected length and a flow resistance ratio when the flow rate is varied;

FIG. 7 is a diagram illustrating a relationship of the embodiment and a pump between a flow rate and a flow resistance when the flow resistance is varied; and

FIG. 8 is a diagram illustrating a relationship of the embodiment between a flow rate and a heat radiation amount ratio when its flow resistance is varied.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

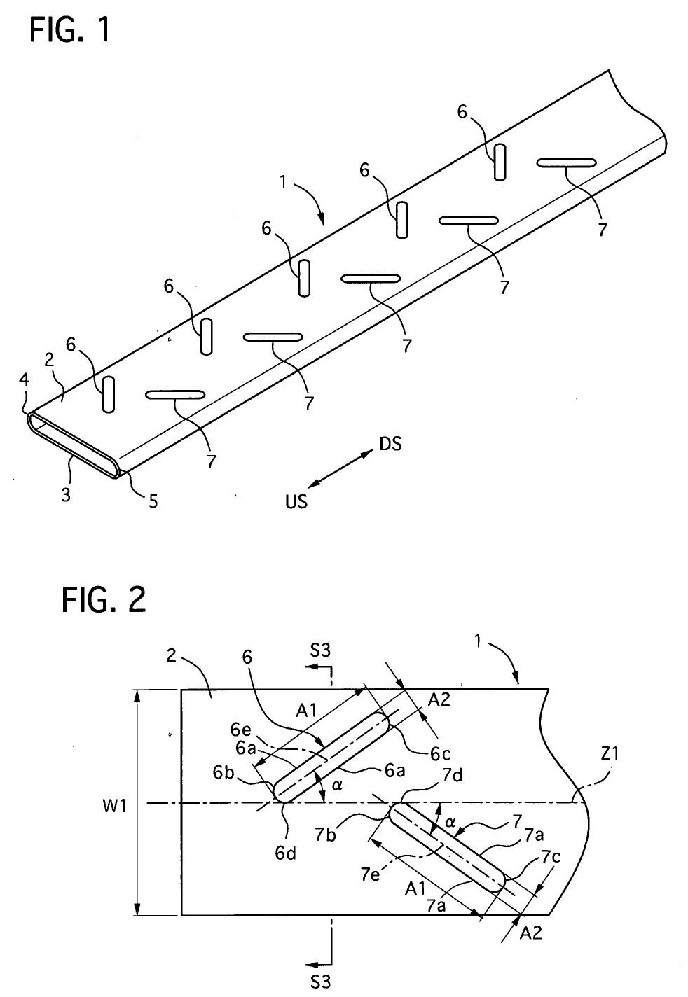

Referring to FIG. 1 of the drawing, there is shown a preferred embodiment of a flat tube 1 according to the present invention. The flat tube 1 is sandwiched by not-shown fins and used for a not-shown heat exchanger, such as a radiator, mounted on a motor vehicle for example. It is manufactured by press-forming or by roll-forming a metal plate, with a high heat transfer property, made of aluminum alloy or the like.

The flat tube 1 has an upper flat wall portion 2, a lower flat wall portion 3 located in parallel with the upper flat wall portion 2, a pair of curved side wall portions 4 and 5 continuously connecting with one-side side portions of the flat wall portions 2 and 3 and with the other-side side portions thereof to form a passage therein for flowing cooling medium such as coolant.

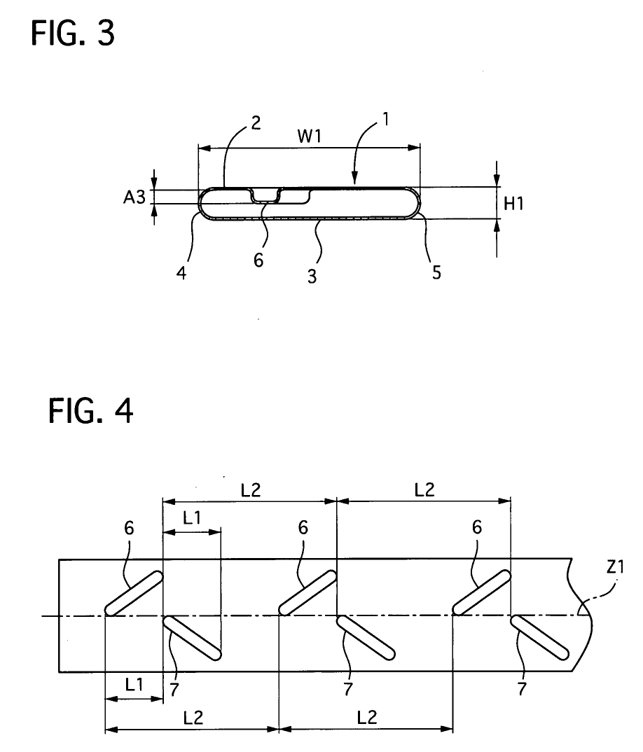

The upper flat tube 2 is provided with plurality of pairs of dimple portions, which are arranged along a longitudinal direction of the flat tube 1. Specifically, as shown in FIGS. 2 and 3, one pair of the dimple portions consists of a first dimple portion 6 and a second dimple portion 7, both of which are formed to have the same dimensions and projected toward an inner space of the flat tube 1, namely the passage, to have a U shape in cross section as shown in FIG. 3.

As shown in FIG. 2, the first dimple portion 6 includes straight side wall portions 6a, an inner end wall portion 6b and an outer end wall portion 6c, where the inner end wall portion 6b is formed to have a half round shape and continuously connect inner edge portions of the straight side wall portions 6a and the outer end wall portion 6c is also formed to have a half round shape and continuously connect outer edge portions thereof. Similarly, the second dimple portion 7 includes straight side wall portions 7a, an inner end wall portion 7b and an outer end wall portion 7c, where the inner end wall portion 7b is formed to have a half round shape and continuously connect inner edge portions of the straight side wall portions 7a and the outer end wall portion 7c is also formed to have a half round shape and continuously connect outer edge portions thereof.

The first dimple portion 6 and the second dimple portion 7 are arranged so that the inner end wall portion 6b of the first dimple portion 6 and the inner end wall portion 7b of the second dimple portion 7 are positioned on an intermediate line Z1 at their portions 6d and 7d of the inner end wall portions 6b and 7b, respectively, where the line Z1 extends in the longitudinal direction of the flat tube 1 at its center position in a lateral direction of the flat tube 1 in this embodiment. The intermediate line Z1 does not need to be correspondent to a center line in the lateral direction, and may be dislocated from the center line as long as the first dimple portions 6 and the second dimple portions 7 can be formed.

The first dimple portion 6 and the second dimple portion 7 are arranged so that they are dislocated from each other in the longitudinal direction of the flat tube 1 so that the outer end wall portion 6c of the first dimple portion 6 is located at the substantially same position in the longitudinal direction as that of the inner end wall portion 7b of the second dimple portion 7, although they are dislocated from each other in the lateral direction of the flat tube 1. The outer end wall portion 7c of the second dimple portion 7 is located at the substantially same position in the longitudinal direction as that of an inner end wall portion of a first dimple position which is included in a pair of dimple portions adjacent to the second dimple portion 7. Thus, the first dimple portions 6 and the second dimple portions 7 are arranged alternately to each other in the longitudinal direction as shown in FIG. 1.

In addition, the first dimple portion 6 and the second dimple portion 7 are slanted by a predetermined slanted angle a relative to the intermediate line Z1 so that they increase a lateral distance between the outer end wall portion 6c of the first dimple portion 6 and the outer end wall portion 7c of the second dimple portion 7 toward a downstream side of the flat tube 1, the outer end wall portions 6c and 7c being apart from the intermediate line Z1 toward the opposite lateral directions.

The first and second dimple portions 6 and 7 are press-formed on a metal plate, to be the flat tube 1, in advance of the press-forming or roll-forming in this embodiment, but they may be formed by other processing and at other processing time. Incidentally, the predetermined slanted angle α, a length A1, a width A2 and a height A3 shown in FIG. 3 of the first and second dimple portions 6 and 7 may be set arbitrarily, and a width W1 and a height H1 of the flat tube 1 may also set arbitrarily. An offset amount in the longitudinal direction between the first dimple portion 6 and the second dimple portion 7 may be set arbitrarily.

A longitudinal pitch L2 is set to be 3 to 12 times a longitudinal projection length L1, where the longitudinal projection length L1 is defined as a length obtained by projecting the first dimple portion 6 or the second dimple portion 7 on the intermediate line Z1, and a longitudinal pitch L2 is defined as a length between the adjacent pairs of the dimple portions, equal to a length between the first dimple portions 6 and 6 and also equal to a length between the adjacent second dimple portions 7 and 7. That is, it can be expressed as the following inequality: 3×L1≦L2≦12×L1, which can be also expressed by using a pitch-length ratio (L2/L1) as the following inequality: 3≦L2/L1≦12. Incidentally, as shown in FIG. 4, in the flat tube of this embodiment shown in FIGS. 1, 2 and 4, the longitudinal pitch L2 is set to be four times the longitudinal projection length L1.

Thus-constructed flat tubes 1 are used for tubes of a heat exchanger, for example, a radiator core of a radiator mounted on a motor vehicle. When it flows in the passage formed inside of the flat tubes 1 from the upstream side US toward the down stream side DS, which are shown in FIG. 1, the cooling medium is cooled down through heat transfer between the cooling medium and an air flow, generated by a not-shown motor fan and/or during vehicle running, hitting the flat tubes 1. The cooling medium becomes turbulent when it hits and passes over the first and second dimple portions 6 and 7, which promotes heat transfer therebetween.

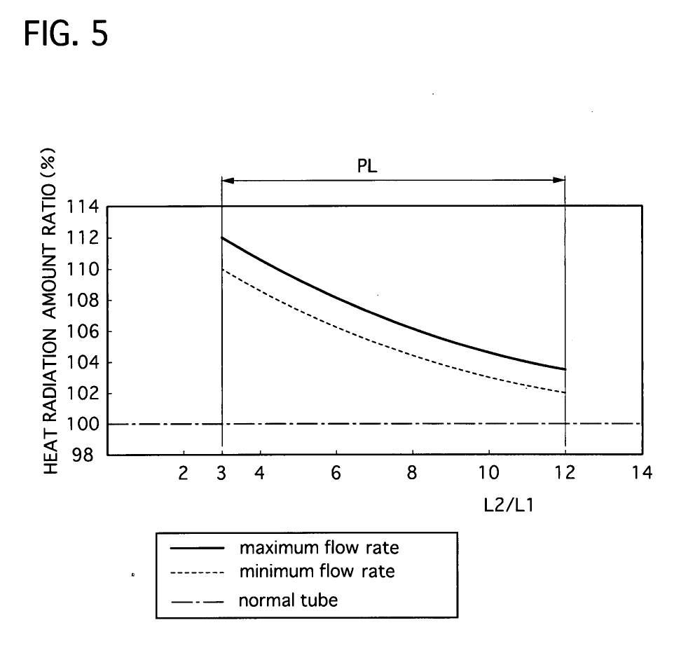

Experimental results of the flat tube 1 of the embodiment are shown in FIG. 5, which shows a relationship between a ratio of the longitudinal pitch L2 to the longitudinal projection length L1 and a heat radiation amount ratio, when the pitch-length ratio (L2/L1) is varied. The heat radiation amount ratio is defined as a ratio of a heat radiation amount of the flat tube 1 to that of a normal flat tube having no dimple portion.

In this experiment, a core of the radiator is 347 mm high, 710 mm long and 27 mm wide, and has a plurality of the flat tubes 1 of the embodiment through which the cooling medium is set to flow at flow rates of 40-80 liters per minute (L/min). In addition, the predetermined slanted angle α is set to be 30°, the length A1 of the dimple portion 6, 7 is set to be 8 mm, the width A2 of the dimple portion 6, 7 is set to be 1.5 mm, and the height of the dimple portion 6, 7 is set to be 0.3 mm.

A reason why the pitch-length ratio (L2/L1) of the flat tube 1 of the embodiment is limited to a ratio range PL where it is 3-12, shown in FIG. 5, is that it needs to be determined allowing for a balance relationship between the heat radiation amount ratio and a flow resistance ratio of the flat tube 1. The heat radiation amount ratio and the flow resistance ratio are in a trade-off relationship therebetween.

As seen from the experimental results shown in FIG. 5, the heat radiation amount ratio becomes larger as the pitch-length ratio (L2/L1) becomes smaller.

When the pitch-length ratio is set to be three (L2/L1=3) which is the smallest value in the ratio range PL, the heat radiation amount ratio at the maximum flow rate (approximately 80 L/min) of the cooling medium is approximately 112% and the pitch-length ratio at the minimum flow rate (approximately 40 L/min) thereof is approximately 110%. This indicates that the heat radiation amount ratio increases by 10-12% at the pitch-length ratio being three (L2/L1=3), relative to that of the normal flat tube. On the other hand, when the pitch-length is set to be twelve (L2/L1=12) which is the largest value in the ratio range PL, the heat radiation amount ratio at the maximum flow rate is approximately 104% and the pitch-length ratio at the minimum flow rate is approximately 102%, both of which are higher than that of the normal flat tube. Therefore, the pitch-length ratio which is no less than three (L2/L1≧3) is desirable, because its heat radiation amount ratio is superior to that of the normal flat tube.

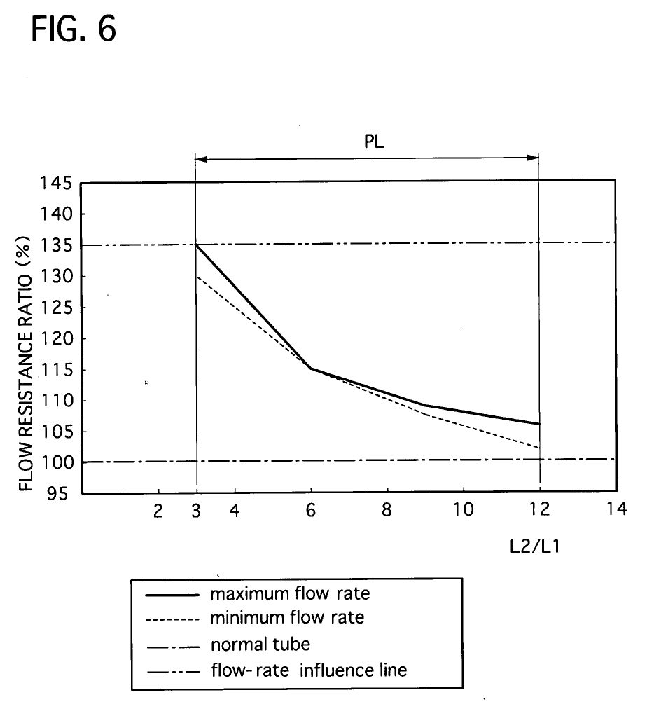

A relationship between the pitch-length ratio (L2/L1) and the flow resistance ratio of the flat tube 1 of the embodiment, relative to those of the normal flat tube, is shown in FIG. 6. The flow resistance of the flat tube 1 becomes larger as the pitch-length ratio (L2/L1) becomes smaller.

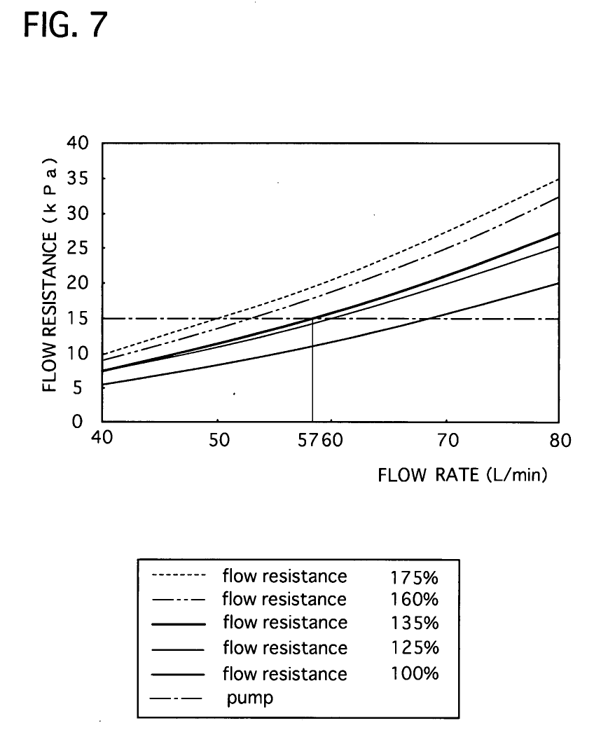

When the pitch-length ratio is set less than three (L2/L1<3), as shown in FIG. 6, the flow resistance ratio of the flat tube 1 of the first embodiment rises over 135% at the maximum flow rate, relative to that of the normal flat tube. When the flow resistance ratio is beyond 135%, a flow rate which is necessary for a radiator of normal motor vehicles, such as a passenger car, becomes approximately 57 L/min, and cannot be obtained, allowing for a flow resistance being 15 kilo-pascal (KPa) as shown in FIG. 7 when a pump of the radiator works at 3000 revolutions-per-minute (rpm) engine speed. Therefore, the pitch-length ratio which is smaller than three (L2/L1<3) is undesirable for being adapted, because of lack of necessary flow rate of the cooling medium due to its flow resistance ratio being too large. Incidentally, in FIG. 6, the flow resistance ratio of 135% is indicated by a two dashed line as a flow-rate influence line, and FIG. 7 shows a relationship between the flow rate and the flow resistance when the flow resistance is varied.

On the other hand, when the pitch-length ratio is set more than twelve (L2/L1>12), the cooling medium which is turbulent due to the pair of the dimple portions 6, 7 becomes to be rectified before reaching the next pair of dimple portions located at the downstream side. The pairs of the dimple portions 6 and 7 next to each other in the longitudinal direction cannot produce their multiplier effect on turbulence of the cooling medium, consequently suppressing the heat radiation ratio. The heat radiation ratio of the flat tube 1 with the pitch-length ratio more than twelve (L2/L1>12) increases only by 2% relative to that of the normal flat tube, which makes it difficult to adapt the pitch-length ratio more than twelve because its cost performance is very low.

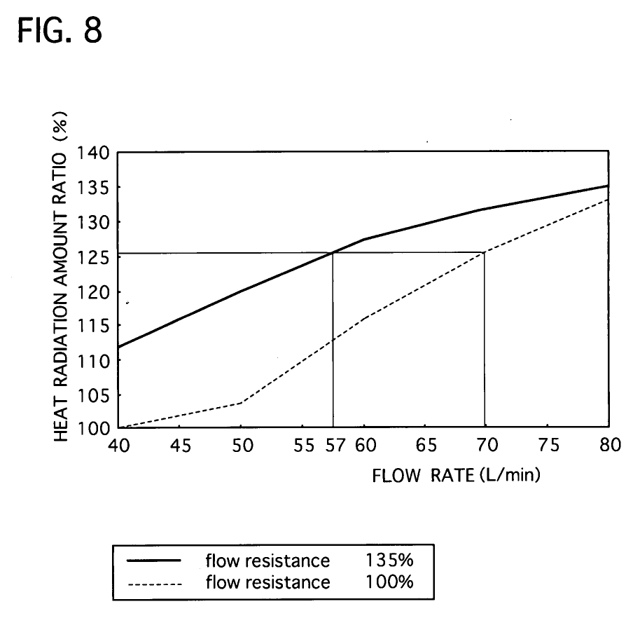

A relationship between the flow rate and the heat radiation amount ratio of the cooling medium when the flow resistance is varied is shown in FIG. 8. In FIG. 8, a thick solid line indicates experimental results when the flat tube 1 with the pitch-length ratio of three (L2/L1=3) and the flow resistance of 135% is supplied with the cooling medium at the flow rate of 40 to 80 L/min, while a thin dashed line indicates experimental results when the normal flat tube without the dimple portion is supplied with the cooling medium at the same flow rate. As seen from FIG. 8, in order to obtain the heat radiation ratio of approximately 125%, the flat tube 1 with pitch/length ratio (L2/L1) of 3 needs the flow rate of approximately 57 L/min, while the normal flat tube needs the flow rate of approximately 70 L/min. This shows that the flat tube 1 of the embodiment can obtain excellent heat radiation performance by less flow rate of the cooling medium, relative to that of the normal flat tube.

As understood by the above-described description, the pitch-length ratio (L2/L1) is set to be from three to twelve in this embodiment, allowing for the heat radiation ratio and the flow resistance of the flat tube 1.

In the flat tube 1 of the embodiment, the pairs of the dimple portions are arranged in the longitudinal direction, each of the pairs thereof including the first dimple portion 6 and the second dimple portion 7 which are slanted in different sides of the intermediate line Z1, and the pitch-length ratio (L2/L1) is set to be three to twelve. Therefore, the flat tube 1 of the embodiment can optimize the pitch of dimple portions of the adjacent pairs to promote the turbulence of the cooling medium and suppress its flow resistance, thereby improving its heat radiation performance.

While there have been particularly shown and described with reference to preferred embodiments thereof, it will be understood that various modifications may be made therein, and it is intended to cover in the appended claims all such modifications as fall within the true spirit and scope of the invention.

For example, the flat tube 1 may be adapted for tubes of a condenser, an inter cooler, or a general heat exchanger, although it is used for the radiator in the above-described embodiment.

The effects similar to those of the embodiment can be obtained because of occurrence of turbulent flow of cooling medium when it flows in the flat tube 1 of the first embodiment in a reverse direction, in other words, a direction from the downstream side toward the upstream side shown in FIG. 1, which is confirmed through experiment.

Detailed configurations of the flat tube 1 and the first and second dimple portions 6 and 7 may be designed arbitrarily.

The first and second dimple portions 6 and 7 may be formed on the lower flat wall portion 3 of the flat tube 1 and may be formed on both of the upper flat wall portion 2 and the lower flat wall portion 3.

The entire contents of Japanese Patent Application No. 2006-163077 filed Jun. 13, 2006 are incorporated herein by reference.

What is claimed is:

1. A flat tube adapted for a heat exchanger comprising:
an upper flat wall portion having two side-end portions,
a lower flat wall portion having two side-end portions, and
two side wall portions continuously connecting the side-end portions of the upper flat wall portion and the side-end portions of the lower flat wall portions, respectively, to from a rectangular cross-sectional passage of cooling medium inside the flat tube, wherein
at least one of the upper flat wall portion and the lower flat wall portion is provided with a plurality of pairs of dimple portions which project toward the passage and arranged in a longitudinal direction of the flat tube, each of the pairs of the dimple portions including a first dimple portion and a second dimple portion which have the same length and are dislocated from each other in the longitudinal direction, the first dimple portion having an inner end wall portion and an outer end wall portion, and the second dimple portion having an inner end wall portion and an outer end wall portion, wherein
the first dimple portion and the second dimple portion are slanted with respect to an intermediate line extending in the longitudinal direction at an intermediate position in a lateral direction of the flat tube so that the inner end wall portion of the first dimple portion and the inner end wall portion of the second dimple portion are located on the intermediate line, and so that the outer end wall potion of the first dimple portion and the outer end wall portion of the second dimple portion depart from the intermediate line in the lateral direction to be toward the side-end portions, respectively, and wherein
the pairs of dimple portions are set to satisfy a relationship expressed by an inequality: 3≦L2/L1≦12, where L1 is a longitudinal projection length obtained by projecting one of the first and second dimple portions on the intermediate line, and L2 is a longitudinal pitch between adjacent pairs of the dimple portions.
